(19) United States
(12) Patent Application Publication
(10) Pub. No.: US 2011/0195178 A1
(43) Pub. Date: Aug. 11, 2011

(54) PRODUCTION METHOD OF DIELECTRIC CERAMIC COMPOSITION AND PRODUCTION METHOD OF ELECTRONIC DEVICE

(75) Inventors: Takashi KOJIMA, Tokyo (JP); Tomoya SHIBASAKI, Tokyo (JP)

(73) Assignee: TDK CORPORATION, Tokyo (JP)

(21) Appl. No.: 13/017,697

(22) Filed: Jan. 31, 2011

(30) Foreign Application Priority Data
Feb. 9, 2010 (JP) 2010-026921

(51) Int. Cl. B05D 5/12; C04B 35/468; B05D 3/02

(52) U.S. Cl. 427/126.3; 501/137; 501/138; 501/139

(57) ABSTRACT

Production method of dielectric ceramic composition including a main component of (Ba_{1-x-y}SrₓCa_{y})ₘ(Ti_{1-z}Zr_{z})O₃ comprises steps of preparing materials of a first main component of (Ba_{1-x1-y}Srₓ₁Ca_{y})ₘ(Ti_{1-z}Zr_{z})O₃ and a second main component of (Ba_{1-x2-y}Srₓ₂Ca_{y})ₘ(Ti_{1-z}Zr_{z})O₃, obtaining a material of the main component by mixing materials of the first and second main component, and fixing the material of the main component. When molar numbers of main component, first main component and second main component are 1, “a” and “b”, respectively, a+b=1, a:b=20:80 to 80:20, 0.20≦x≦0.40, x=(ax1+bx2), x1/x2≧1.05, 0≦y≦0.20, 0≦z≦0.30 and 0.950≦m≦1.050. By the present invention, the dielectric ceramic composition in which capacitance change rate is, set to the predetermined range with respect to an absolute value of capacity temperature characteristic, which is large, within wide temperature range can be obtained.

### BACKGROUND OF THE INVENTION

1. Field of the Invention

The present invention relates to production methods of a dielectric ceramic composition and an electronic device. For more detail, the present invention relates to a production method of a dielectric ceramic composition which is able to set a capacitance change rate to a predetermined range with respect to an absolute value of a capacity temperature characteristic within a wide temperature range even when the absolute value is large; and also the present invention relates to a production method of an electronic device having a dielectric layer composed of said dielectric ceramic composition.

2. Description of the Related Art

VR (Voltage Regulator) is a system regulating voltage of DC/DC converter, which drives CPU of a notebook computer or so. An inductor resistance (Rdc) detects an output current of VR, however, there was a problem that an error arises in the detected value since Rdc varies due to heat or so. Therefore, it is required to use properly within a wide temperature range.

In the present state, NTC thermistor is used to revise the error of the detected value.

Further, the capacitor is normally used for a circuit of VR system. It is thought that, by using the capacitor showing large absolute value of the capacity temperature characteristic, such as around −5000 ppm/° C., the error can be revised. As a result of using this method, NTC thermistor is not required, and its cost is reduced, which is an advantage.

On the other hand, there is a demand for a capacitor showing small absolute value of the capacity temperature characteristic (the capacitance change is small with respect to the temperature change), therefore, a capacitor showing large absolute value of the capacity temperature characteristic is scarcely informed. Note that the absolute value of the capacity temperature characteristic of normal capacitor is at most around −1000 ppm/° C. or 350 ppm/° C.

Japanese Utility Model Publication No. H5-61998 describes a ceramic capacitor using a ceramic as a dielectric which shows the capacity temperature characteristic of −1500 ppm/° C. to −5000 ppm/° C. and includes 20 to 95 wt % of SrTiO₃. However, the composition of the dielectric layer of the ceramic capacitor described in Japanese Utility Model Publication No. H5-61998 is partially unidentified and the other components are totally unidentified. Further, the publication does not indicate that the temperature range in which the above capacitor temperature characteristic is realized.

### BRIEF SUMMARY OF THE INVENTION

A purpose of the present invention, reflecting this situation, is to provide a production method of a dielectric ceramic composition which is able to set capacitance change rate to a predetermined range with respect to absolute value of capacity temperature characteristic within a wide temperature range even when the absolute value is large, and a production method of an electronic device having a dielectric layer composed of the dielectric ceramic composition.

As a result of keen examination in order to attain the above purpose, the present inventors found that a dielectric ceramic composition having a large capacity temperature characteristic (for example, −7000 to −3000 ppm/° C.) can be produced by using a plurality of materials having different composition as a material of a main component, which led to a completion of the invention.

To attain the above purpose, a production method of a dielectric ceramic composition according to the present invention is a production method of a dielectric ceramic composition including a main component expressed by a general formula of (Ba_{1-x-y}SrₓCa_{y})ₘ(Ti_{1-z}Zr_{z})O₃. The method has a step of preparing a material of a first main component expressed by a general formula of (Ba_{1-x1-y}Srₓ₁Ca_{y})ₘ(Ti_{1-z}Zr_{z})O₃ and a material of a second main component expressed by a general formula of (Ba_{1-x2-y}Srₓ₂Ca_{y})ₘ(Ti_{1-z}Zr_{z})O₃, a step of obtaining a material of the main component by mixing the material of the first main component and the material of the second main component and a step of firing the material of the main component. In the method, when a molar number of the main component is 1, a molar number of the first main component is “a” and a molar number of the second main component is “b”, a+b=1 and a:b=20:80 to 80:20, and the “x”, “x1”, “x2”, “a” and “b” satisfy relations of 0.20≦x≦0.40, x=(ax1+bx2) and x1/x2≧1.05, and the “y” is 0≦y≦0.20, the “z” is 0≦z≦0.30 and the “m” is 0.950≦m≦1.050.

Preferably, in the production method of a dielectric ceramic composition, the dielectric ceramic composition includes a first subcomponent consisting of an oxide of Mg, a second subcomponent consisting of an oxide of at least one kind of element selected from Mn and Cr, a third subcomponent consisting of an oxide of R, where R is at least one kind selected from Y, La Ce, Pr, Nd, Sm, Gd, Tb, Dy, Ho and Yb, and a fourth subcomponent consisting of an oxide including Si and ratios of the respective subcomponents with respect to 100 moles of the main component are

the first subcomponent: 0.5 to 5 moles in terms of element,
the second subcomponent: 0.05 to 2 moles in terms of element,
the third subcomponent: 1 to 8 moles in terms of element and
the fourth subcomponent: 0.5 to 5 moles in terms of an oxide or a composite oxide.

Preferably, the dielectric ceramic composition further includes a fifth subcomponent consisting of an oxide of at least one kind of element selected from V, Mo, W, Ta and Nb and a ratio of the fifth subcomponent with respect to 100 moles of the main component is 0 to 0.2 moles in terms of each element.

A production method of an electronic device according to the present invention is a production method of an electronic device having a dielectric layer and an electrode layer. In the method, dielectric layer is composed of a dielectric ceramic composition including a main component expressed by a general formula of (Ba_{1-x-y}SrₓCa_{y})ₘ(Ti_{1-z}Zr_{z})O₃. The method has a step of preparing a material of a first main component expressed by a general formula of (Ba_{1-x1-y}Srₓ₁Ca_{y})ₘ(Ti_{1-z}Zr_{z})O₃ and a material of a second main component expressed by a general formula of (Ba_{1-x2-y}Srₓ₂Ca_{y})ₘ(Ti_{1-z}Zr_{z})O₃, a step of obtaining a material of the main component by mixing said material of the first main component and the material of the second main component, a step of forming a dielectric layer before firing including the material of the main component and a step of firing said dielectric layer before firing. In the method, when a molar number of the main component is 1, a molar number of the first main component is “a” and a molar number of the second main component is “b”, a+b=1 and a:b=20:80 to 80:20, and the “x”, “x1”, “x2”, “a” and “b” satisfy relations of 0.20≦x≦0.40, x=(ax1+bx2) and x1/x2≧1.05, and the “y” is 0≦y≦0.20, the “z” is 0≦z≦0.30 and the “m” is 0.950≦m≦1.050.

An electronic device produced by the method according to the present invention is not particularly limited, and is, for example, a multilayer ceramic capacitor having a capacitor element body in which dielectric layers and internal electrode layers are alternately stacked.

According to the present invention, by using a plurality of materials which have different compositions as a material of the main component, within a wide temperature range (e.g. −25 to 105° C. or −55 to 150° C.), the dielectric ceramic composition which is able to set a capacitance change rate on the basis of a capacitance at 25° C. to the range of −15 to +5%, with respect to slope “a” which shows capacity temperature characteristic on the basis of the capacitance at 25° C., can be produced. The slope “a” is an extremely large value which is in the range of −7000 to −3000 ppm/° C., which is characteristic.

Also, for example, by changing a composition ratio of a plurality of materials of a main component or including subcomponents and so on, within the wider temperature range, a capacitance change rate with respect to the slope “a” can be set within the narrower range.

Accordingly, by producing an electronic device by using a dielectric ceramic composition produced by the present invention as the dielectric layer of electronic device such as multilayer ceramic capacitor, an electronic device which is able to revise an error of a detected value of the output voltage of VR caused by variation of Rdc without, for instance, using NTC thermistor can be obtained. Further, as fax as the dielectric ceramic composition produced by the present invention is used and its absolute value of the capacity temperature characteristic is required to be large, its application is not particularly limited.

Reasons for capability of obtaining these dielectric ceramic compositions can be said as following.

An absolute value of the capacity temperature characteristic of SrTiO₃ is relatively large (−3300 ppm/° C.), however, a peak of its specific permittivity is shown at a considerably low temperature when compared to an ordinal temperature range (−25° C. to 105° C.). Note that the peak is shown near Curie temperature.

Therefore, by shifting this peak toward a higher temperature, a part showing a large inclination at a higher temperature than the temperature shown by the peak will be within an ordinal temperature range. As the method for shifting the peak toward a higher temperature, it can be considered to substitute a part of SrTiO₃ to Ba. Since an element having a large ionic radius, such as Ba, has an effect to shift the peak toward a higher temperature, the peak of specific permittivity is shifted toward a higher temperature, therefore, the part showing the large inclination at the higher temperature than the temperature shown by the peak will be within the above temperature range (−25° C. to 105° C.).

In the present invention, by using a plurality of materials which have different compositions as a material of a main component, the above temperature range can be set widely with maintaining an extremely large capacity temperature characteristic and, in addition, change rate with respect to the capacity temperature characteristic can be set within a narrower range.

Further, by including subcomponents, a slope with a large inclination, namely, a large absolute value of the capacity temperature characteristic can be maintained and the capacitance change rate can be set in a predetermined range while attaining desirable characteristics.

### BRIEF DESCRIPTION OF THE DRAWINGS

FIG. 1 is a perspective view of a multilayer ceramic capacitor produced by a production method according to an embodiment of the present invention.

FIG. 2A is a graph showing a parallelogram surrounded by lines showing a capacitance change rate of ˜15 and +5%, respectively, with respect to a line showing a capacity temperature characteristic on the basis of capacitance at 25° C. and having a slope of −5000 ppm/° C., and also by lines showing temperatures of −25° C. and 105° C., respectively.

FIG. 2B is a graph showing a parallelogram surrounded by lines showing the capacitance change rate of −15 and +5%, respectively, with respect to a line showing the capacity temperature characteristic on the basis of capacitance at 25° C. and having a slope of −3000 ppm/° C., and also by lines showing temperatures of −25° C. and 105° C., respectively.

FIG. 3 is a graph showing capacity temperature characteristic on the basis of capacitance at 25° C. of samples 1 and 4.

### DETAILED DESCRIPTION OF THE INVENTION

Hereinafter, the present invention will be described based on embodiments shown in drawings.

(Multilayer Ceramic Capacitor 1)

A multilayer ceramic capacitor 1 as an example of an electronic device produced by the method according to the present invention has a capacitor element body 10 in which dielectric layers 2 and internal electrode layers 3 are alternately stacked. On both end portions of the capacitor element body 10, a pair of external electrode 4 is formed to be connected respectively to the internal electrode layers 3 alternately arranged inside the element body 10. The shape of the capacitor element body 10 is not particularly limited and generally rectangular parallelepiped. Further, the size of the capacitor element body 10 is not particularly limited and it may be decided appropriately in accordance with the use.

The internal electrode layers 3 are stacked, so that each of the end surfaces is alternately exposed to surfaces of the two facing end portions of the capacitor element body 10. The pair of external electrodes 4 are formed on both end portions of the capacitor element body 10 and connected to the exposed end surfaces of the alternately arranged internal electrode layers 3 so as to compose a capacitor circuit.

(Dielectric Layer 2)

In the present embodiment, the dielectric layer 2 includes a dielectric ceramic composition described below. The dielectric ceramic composition includes a main component expressed by a general formula (Ba_{1-x-y}SrₓCa_{y})ₘ(Ti_{1-z}Zr_{z})O₃, a first subcomponent consisting of an oxide of Mg, a second subcomponent consisting of an oxide of at least one kind of element selected from Mn and Cr, a third subcomponent consisting of an oxide of R, where R is at least one kind selected from Y, La Ce, Pr, Nd, Sm, Gd, Tb, Dy, Ho and Yb, and a fourth subcomponent consisting of an oxide including Si.

The main component of dielectric composition is a compound having a perovskite structure expressed by the above general formula; in the perovskite structure, Ba, Sr and Ca occupy an A site, and Ti and Zr occupy a B site.

In the general formula, “x” indicates Sr ratio in A site (Ba, Sr and Ca) of main component, “x” is 0.20≦x≦0.40, preferably 0.25≦x≦0.35. When “x” is too small, a dielectric loss and the capacitance change rate tend to deteriorate, while when too large, a specific permittivity tends to reduce and capacitance change rate at a lower temperature tends to deteriorate.

Also, in the general formula, “y” indicates Ca ratio in A site, “y” is 0≦y≦0.20, preferably 0≦y≦0.1, more preferably y is 0. When “y” is too large, capacitance change rate is flattened and tends to exceed a preferable range of the invention.

Also, in the general formula, “z” indicates Zr ratio in B site (Ti and Zr_{z}) of the main component, “z” is 0≦z≦0.30, preferably 0≦z≦0.1, more preferably z is 0. When “z” is too large, specific permittivity reduces and the capacitance change rate is flattened and tends to exceed a preferable range of the invention.

Note that when y is 0 and z is 0, the above general formula is expressed by (Ba₁₋ₓSrₓ)ₘTiO₃ where “x” indicates a ratio of Ba and Sr. Even in this case, it is preferable that “x” is within the above mentioned range.

In the above general formula, “m” indicates molar ratio between an element occupying A site and an element occupying B site of the main component. “m” is 0.950 to 1.050, preferably 0.98 to 1.02.

Content of the first subcomponent (the oxide of Mg) with respect to 100 moles of the main component is 0.5 to 5 moles, preferably 1 to 4 moles, more preferably 1.5 to 3 moles in terms of an element. When the content of the first subcomponent is too small, the capacitance change rate tends to deteriorate and a high temperature load lifetime tends to be deteriorated, while when too large, it tends not to sinter densely.

The second subcomponent consists of at least one kind selected from oxides of Mn and Cr. The oxide of Mn is preferable in view of insulation resistance.

The content of the second subcomponent with respect to 100 moles of the main component is 0.05 to 2 moles, preferably 0.1 to 1 mole, more preferably 0.1 to 0.5 mole in terms of an element. When the content of the second subcomponent is too small, the insulation resistance tends to deteriorate while when too large, the high temperature load lifetime tends to be deteriorated.

R in the third subcomponent is at least one kind selected from Y, La Ce, Pr, Nd, Sm, Gd, Tb, Dy, Ho and Yb. Tb and Y are preferable and Y is more preferable in view of the high temperature accelerated lifetime and the capacitance change rate.

The content of the third subcomponent (oxide of R) with respect to 100 moles of the main component is 1 to 8 moles, preferably 2 to 7 moles, more preferably 3 to 5 moles in terms of an element. When the content of the third subcomponent is too small, the high temperature load lifetime tends to be deteriorated, while when too large, it tends not to sinter densely.

Content of the fourth subcomponent (the oxide including Si) with respect to 100 moles of the main component is 0.5 to 5 moles, preferably 1 to 4.5 moles, more preferably 2 to 3.5 moles in terms of the oxide. When the content of the fourth subcomponent is too small, the capacitance change rate tends to deteriorate, while when too large, it tends not to sinter densely.

The oxide including Si may be a composite oxide or a simple oxide, however, composite oxide is preferable and (Ba, Ca)ₙSiO₂₊ₙ (note that n=0.8 to 1.2) is more preferable. Further, “n” in (Ba, Ca)ₙSiO₂₊ₙ is preferably 0 to 2 and more preferably 0.8 to 1.2. When “n” is too small, it tends to react with barium titanate included in a main component and deteriorate the dielectric characteristic, while when too large, a melting point tends to be higher and a sinterablity tends to be deteriorated. Note that ratio of Ba and Ca included in the fourth subcomponent is optional and only either one may be included.

The above dielectric ceramic composition preferably includes a fifth subcomponent in addition to the above main component and first to fourth subcomponents. The fifth subcomponent is an oxide of at least one kind of element selected from V, Mo, W, Ta and Nb, it is preferably the oxide of Nb and V, and more preferably the oxide of V in view of the high temperature accelerated lifetime.

The content of the fifth subcomponent with respect to 100 moles of the main component is 0 to 0.2 mole, preferably 0.01 to 0.07 mole, more preferably 0.02 to 0.06 mole in terms of each element. When the content of the fifth subcomponent is too large, the insulation resistance tends to be deteriorated.

In the present specification, each oxide or composite oxide comprising each component are expressed by a stoichiometric composition but oxidized state of each oxide or composite oxide can be out of this range. Note that the above ratio of each component, except for the fourth subcomponent, is obtained in terms of the element of the metal amount included in an oxide of each component. The fourth subcomponent is obtained in terms of the same to oxide or composite oxide.

Note that an average particle diameter of the sintered body obtained by sintering the above main component and subcomponents is preferably 0.2 to 1.5 μm, more preferably 0.2 to 0.8 μm.

The thickness of dielectric layer 2 is not particularly limited and can be an appropriate thickness in accordance with the use of the multilayer ceramic capacitor 1.

Since the above dielectric ceramic composition is produced by the method mentioned below, within the extremely wide temperature range, which is the range of −55° C. to 150° C., a capacitance change rate on the basis of capacitance at 25° C. is within the extremely narrow range, which is the range of −10 to +5%, with respect to slope “a” which shows capacity temperature characteristic on the basis of capacitance at 25° C.

In addition, the slope “a” is an extremely large value which is in the range of −7000 to −3000 ppm/° C., and is controlled in the above range by changing the composition of the main component and the compositions of the subcomponents and so on. The slope “a” is preferably in the range of −6000 to −4000 ppm/° C., more preferably in the range of −5500 to −4500 ppm/° C.

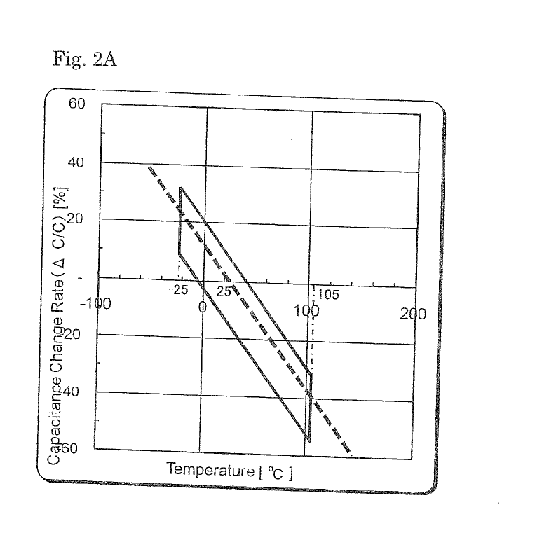

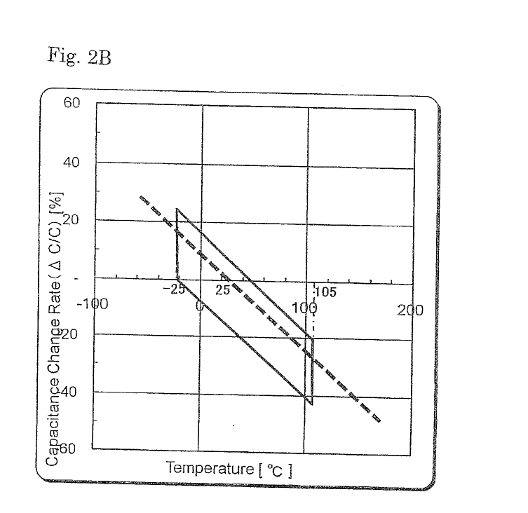

Note that the capacitance change rate with respect to a line showing the slope “a” is explained by using FIG. 2A and FIG. 2B. FIGS. 2A and 2B are graphs on which x-axis represents temperature and y-axis represents capacitance change rate. In the graphs, an area surrounded by two parallel lines representing −15% and +5% and two parallel lines representing −25° C. and 105° C. (parallelogram) is a range of −15% to +5% with respect to the line showing the slope “a”.

Namely, when the slope “a” is −5000 ppm/° C., the area is the parallelogram shown in FIG. 2A, and when the slope “a” is −3000 ppm/° C., the area is the parallelogram shown in FIG. 2B.

(Internal Electrode 3)

The conductive material included in the internal electrode 3 is not particularly limited and, since the constitutional material of the dielectric layer 2 show resistance to reduction, relatively inexpensive base metals can be used. As the base metal used as the conductive material, Ni or a Ni alloy is preferable. As the Ni alloy, an alloy of one or more kinds selected from Mn, Cr, Co and Al with Ni is preferable, and a content of Ni in the alloy is preferably 95 wt % or more, Note that the Ni or the Ni alloy may contain various trace components, such as P, by not more than 0.1 wt % or so. Further, the internal electrode 3 can be made by using the commercially available electrode paste. The thickness of the internal electrode layer 3 in the present embodiment can suitably determined in accordance with its use.

(External Electrode 4)

The conductive material included in the external electrode 4 is not particularly limited and an inexpensive material such as Ni, Cu or their alloys can be used in the present invention. The thickness of the external electrode 4 can suitably determined in accordance with its use.

(Manufacturing Method of Multilayer Ceramic Capacitor 1)

As a production method according to an embodiment of the present invention, production method of a multilayer ceramic capacitor 1 will be described below. As the production method of the multilayer ceramic capacitor 1 is not particularly limited as far as it includes a step of forming a dielectric layer before firing which includes a material of a main component obtained by mixing a material of a first main component and a material of a second main component mentioned below, and a step of firing the dielectric layer before firing. For example, the multilayer ceramic capacitor 1 may be produced by dry forming, wet forming or extrusion.

In the present embodiment, ceramic capacitor is, as the same as the conventional multilayer ceramic capacitor, manufactured by producing a green chip by a normal printing method or a sheet method using a paste, firing the same. The manufacturing method will be concretely described below.

First, the dielectric material (dielectric ceramic composition powder) included in the dielectric layer paste is prepared.

In the present embodiment, a plurality of materials is prepared as main component (Ba_{1-x-y}SrₓCa_{y})ₘ(Ti_{1-z}Zr_{z})O₃ included in, the dielectric material. Specifically, as the material of the first main component, an oxide expressed by a general formula of (Ba_{1-x1-y}Srₓ₁Ca_{y})ₘ(Ti_{1-z}Zr_{z})O₃ is prepared. Also, as the material of the second main component, an oxide expressed by a general formula of (Ba_{1-x2-y}Srₓ₂Ca_{y})ₘ(Ti_{1-z}Zr_{z})O₃ is prepared.

When a molar number of the main component is 1, a molar number of the first main component is “a” and a molar number of the second main component is “b”, a content ratio of the material of the first main component and the material of the second main component is adjusted to satisfy relations of a+b=1 and a:b=20:80 to 80:20.

Also, in the present embodiment, a ratio between the above “x1” (Sr ratio in the first main component) and the above “x2” (Sr ratio in the second main component) satisfies a relation of x1/x2≧1.05

Namely, Sr included in the first main component is larger than Sr included in the second main component, and the first main component and the second main component have different compositions. Also, since the “x1” and “x2” only satisfy the above relation, “x2” may be 0, for example. Namely, the second main component may have composition of (Ba_{1-y}Ca_{y})ₘ(Ti_{1-z}Zr_{z})O₃.

Note that “x” in the main component expressed by the general formula of (Ba_{1-x-y}SrₓCa_{y})ₘ(Ti_{1-z}Zr_{z})O₃ is expressed as (ax1+bx2).

Therefore, a plurality of materials having different Sr ratio may be prepared so as to satisfy the above relations. By doing this, within an extremely wide temperature range, a dielectric ceramic composition in which a capacitance change rate with respect to an extremely large capacity temperature characteristic is in the extremely narrow range can be obtained.

Note that, as the materials of the first main component and the second main component, variety of oxides mentioned above and so on may be used. Further, a mixture suitably selected from compounds that become the above mentioned oxides or composite oxides after firing, such as carbonates, oxalates, nitrates, hydroxides and organic metal compounds, may be used.

Next, when the dielectric ceramic composition includes a subcomponent, a material of the subcomponent is prepared. As the material of the subcomponent, the oxides of each subcomponent mentioned above, their mixtures and composite oxides may be used. Further, a mixture suitably selected from compounds that become the above mentioned oxides or composite oxides after firing, such as carbonates, oxalates, nitrates, hydroxides and organic metal compounds may be used.

Also, as for at least a part of materials of the above first main component, second main component and subcomponents, each oxide, composite oxides, and compounds that become each oxide or composite oxides after firing may be used as they are or as roasted powder obtained by calcining the same.

Note that an average particle diameter of materials of the first main component and the second main component is preferably 0.15 to 0.7 μm, more preferably 0.2 to 0.5 μm. When the average particle diameter of the materials is smaller than 0.15 μm, the average particle diameter of the sintered body becomes 0.2 μm or less. As a result, its specific permittivity is reduced and the capacitance change rate at higher temperature tends to deteriorate. Further, when the average particle diameter of the materials is larger than 0.7 μm, the average particle diameter of the sintered body becomes 1.5 μm or more. As a result, the high temperature accelerated lifetime and the capacitance change rate at lower temperature tend to deteriorate.

The above prepared material of the first main component and material of the second main component are mixed with an organic vehicle, and made into a paste to prepare the dielectric layer paste including the material of the main component. Materials of the subcomponents may be mixed in accordance with need. The dielectric layer paste may be an organic type paste or a water-based paste.

The organic vehicle is obtained by dissolving a binder in an organic solvent. The binder used for the organic vehicle is not particularly limited and may be suitably selected from various normal binders such as ethyl cellulose, polyvinyl butyral and the like. Further, the organic solvent used is also not particularly limited and may be suitably selected from various organic solvents such as terpineol, butyl carbitol, acetone, toluene, and the like in accordance with the method of use, such as a printing method and a sheet method.

When preparing the dielectric layer paste as a water-based paste, a water-based vehicle is obtained by dissolving a water-soluble binder, dispersant, etc. in water, and the dielectric material may be kneaded. The water-soluble binder used for the water-based vehicle is not particularly limited, for example, polyvinyl alcohol, cellulose, and a water-soluble acrylic resin, etc. may be used.

An internal electrode layer paste is prepared by kneading a conductive material and the above mentioned organic vehicle. As the conductive material, the above variety of conductive metals and alloys, or a variety of oxides, organic metal compounds and resonates and the like which become the above conductive materials after firing.

An external electrode paste is prepared in the similar way as that of the above internal electrode layer paste.

A content of the organic vehicle in each paste is not particularly limited and may be a normal content of, for example, 1 to 5 wt % or so of the binder and 10 to 50 wt % or so of the solvent. Also, additives selected from a variety of dispersants, plasticizers, dielectrics and insulators, etc. may be included in each paste in accordance with the need. A total content thereof is preferably 10 wt % or less.

When using the printing method, the dielectric layer paste and internal electrode layer paste are printed on a substrate such as PET, and stacked, removed from the substrate then cut to a predetermined shape to obtain a green chip.

Further, when using the sheet method, the dielectric layer paste is used to form a green sheet, the internal electrode layer paste is printed thereon, then these are stacked and cut to a predetermined shape to obtain a green chip.

Before firing, a binder removal treatment is performed to the green chip. The conditions of the binder removal treatment are; a temperature rising rate is preferably 5 to 300° C./hour, a holding temperature is preferably 180 to 400° C. and a temperature holding time of preferably 0.5 to 24 hours. Further, binder removal atmosphere is air or reduced atmosphere.

Firing Atmosphere can be determined as an appropriate atmosphere in accordance with the conductive material included in internal electrode layer paste, however, when using Ni or Ni alloy or other base metal as the conductive material, the oxygen partial pressure in the firing atmosphere is preferably 10⁻¹⁴ to 10⁻¹⁰ MPa. If the oxygen partial pressure is less than that range, the conductive material of the internal electrode layers will be abnormally sintered and will end up causing disconnection in some cases. Further, if the oxygen partial pressure exceeds that range, the internal electrode layers tend to oxidize.

Further, the holding temperature at the time of firing is preferably 1000 to 1400° C. If the holding temperature is less than the above range, the densification becomes insufficient, while if it is over the above range, the breakage of the electrode due to the abnormal sintering of the internal electrode, deterioration of the capacity temperature characteristic due to the dispersion of the internal electrode layer materials, or a reduction of the dielectric ceramic composition tend to occur.

As the other firing conditions, a temperature rising rate is preferably 50 to 500° C./hour, a temperature holding time is preferably 0.5 to 8 hours, and a cooling rate is preferably 50 to 500° C./hour. Further, the firing atmosphere is preferably a reducing atmosphere.

After firing in a reducing atmosphere, it is preferable that the capacitor element body is annealed. The annealing is a treatment for reoxidizing the dielectric layer. This remarkably extends the IR life, thereby the reliability is improved.

An oxygen partial pressure in the annealing atmosphere is preferably 10⁻⁹ to 10⁻⁵ MPa. Also, a holding temperature at the time of annealing is preferably 1100° C. or below, particularly 500 to 1100° C., a temperature holding time is preferably 0 to 20 hours.

To wet the N₂ gas or a mixed gas etc. in the above binder removal treatment, firing and annealing, for example a wetter etc. may be used. In this case, the water temperature is preferably 5 to 75° C. or so. The binder removal treatment, firing and annealing may be performed continuously or independently.

Thus obtained capacitor element body is end polished and the external electrode paste is printed on there and fired so as to form the external electrodes 4. Further, in accordance with the need, the external electrodes 4 are plated etc. to form covering layers.

Thus produced multilayer ceramic capacitor of the present embodiment is mounted on a printed circuit board by soldering etc. and used for various types of electronic equipments.

An embodiment of the present invention was explained above, but the present invention is not limited to the embodiment and may be variously embodied within the scope of the present invention.

For example, in the above embodiment, a multilayer ceramic capacitor was explained as an example of an electronic device produced by the method according to the present invention, but such electronic device is not limited to a multilayer ceramic capacitor and may be any as far as it includes a dielectric layer having the above composition.

### EXAMPLES

Below, the present invention will be explained based on further detailed examples; however, the present invention is not limited to the examples.

### Example 1

First, as a material of a first main component, (Ba_{1-x1-y}Srₓ₁Srₓ₁Ca_{y})ₘ(Ti_{1-z}Zr_{z})O₃ having an average particle diameter of 0.35 μm and in which “x1” was set to values shown in Tables 1 and 3 was prepared. Next, as a material of a second main component, (Ba_{1-x2-y}Srₓ₂Ca_{y})ₘ(Ti_{1-z}Zr_{z})O₃ having an average particle diameter of 0.35 μm and in which “x2” was set to values shown in Tables 1 and 3 was prepared. Also, as materials of subcomponents, MgCO₃ (a first subcomponent), MnO (a second subcomponent), Y₂O₃ (a third subcomponent), BaCaSiO₃ (a fourth subcomponent) and V₂O₃ (a fifth subcomponent) were prepared.

The materials of the main component and the subcomponents prepared in the above were mixed by a ball mill. The obtained mixed powder was calcined at 1200° C. to obtain a calcined powder having an average particle diameter of 0.4 μm. Next, the obtained calcined powder was wet-pulverized by a ball mill for 15 hours, and then dried to obtain a dielectric material. Note that, after firing, MgCO₃ will be included as MgO in dielectric ceramic composition.

Composition of the main component and contents of respective subcomponents were weighed so as to be amounts or ratios shown in Tables 1 and 3.

Next, 100 parts by weight of the obtained dielectric material, 10 parts by weight of polyvinyl butyral, 5 parts by weight of dibutyl phthalate (DBP) as plasticizer, and 100 parts by weight of alcohol as solvent were mixed by ball mill and made into a paste so as to obtain a dielectric layer paste.

Next, 45 parts by weight of Ni particles, 52 parts by weight of terpineol and 3 parts by weight of ethyl cellulose were kneaded by a triple roll and made into a slurry so as to obtain an internal electrode layer paste.

By using the obtained dielectric layer paste, a green sheet having a thickness of 10 μm after drying was formed on a PET film. Next, by using the internal electrode layer paste, the electrode layer was printed on the green sheet by a predetermined pattern and then, the green sheet was removed from the PET film so as to obtain the green sheet having the electrode layer. Next, a plurality of green sheets having electrode layers were stacked and adhered by pressure to obtain a green multilayer body. The green multilayer body was cut into a predetermined size to obtain a green chip.

Next, the obtained green chip was subjected to a binder removal treatment, firing and annealing under the conditions described in below so as to obtain a multilayer ceramic fired body.

The binder removal treatment condition was a temperature rising rate of 25° C./hour, holding temperature of 250° C., temperature holding time of 8 hours and atmosphere of air.

The firing condition was a temperature rising rate of 240° C./hour, a holding temperature of 1300° C., a temperature holding time of 2 hours, a temperature cooling rate of 200° C./hour and an atmosphere of a wet mixed gas of N₂ and H₂ (oxygen pressure of 10⁻¹² MPa).

The annealing condition was a temperature rising rate of 200° C./hour, a holding temperature of 1100° C., a temperature holding time of 2 hours, a temperature cooling rate of 200° C./hour and an atmosphere of a wet N₂ gas (oxygen pressure of 10⁻⁷ MPa).

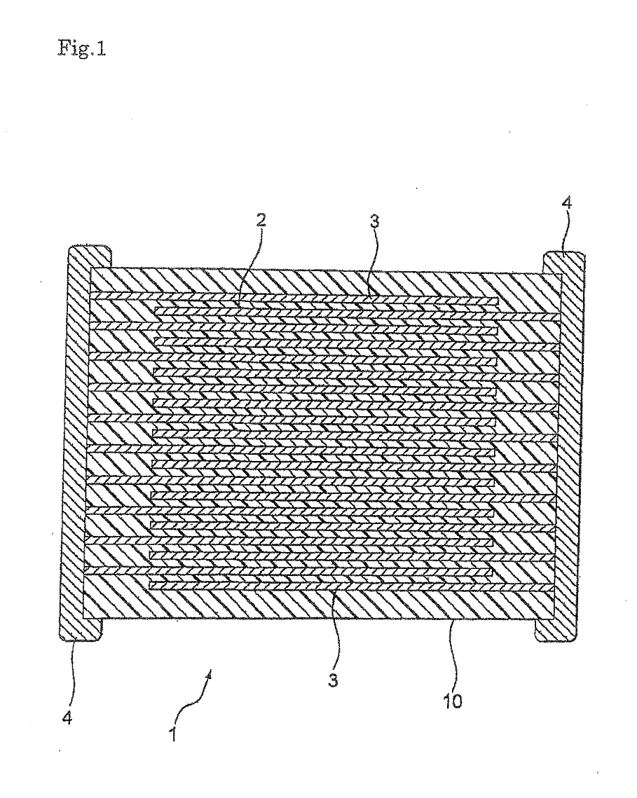

Next, after polishing an end surface of the obtained multilayer ceramic sintered body by sand blast, In—Ga was coated as external electrodes and a sample of the multilayer ceramic capacitor shown in FIG. 1 was obtained. A size of the obtained capacitor sample was 3.2 mm×1.6 mm×3.2 mm, a thickness of dielectric layer was 8 μm, a thickness of internal electrode layer was 1.5 μm and the number of dielectric layers between internal electrode layers was 4.

For the obtained each capacitor sample, a specific permittivity (∈s), a dielectric loss (tan δ), insulation resistance (IR), a capacitance change rate, a high temperature accelerated lifetime (HALT) and an average particle diameter of the sintered body were measured by the methods shown below.

(Specific Permittivity ∈s)

The specific permittivity ∈s was calculated from a capacitance of the obtained capacitor sample measured at a reference temperature of 25° C. with a digital LCR meter (4274A made by YHP) under a condition of a frequency of 1 kHz and an input signal level (measurement voltage) of 1.0 Vrms. Higher specific permittivity is preferable, and in the present example, samples in which specific permittivity was 1000 or higher were determined as good. The results are shown in Tables 2 and 4.

(Dielectric Loss (tan δ))

The dielectric loss (tan δ) was measured from the obtained capacitor sample at a reference temperature of 25° C. with a digital LCR meter (4274A made by YHP) under a condition of a frequency of 1 kHz and an input signal level (measurement voltage) of 1.0 Vrms. Lower dielectric loss is preferable, and in the present example, samples in which dielectric loss was 3% or less were determined as good. The results are shown in Tables 2 and 4.

(Insulation Resistance (IR))

The insulation resistance (IR) was measured when a capacitor sample was impressed with DC100V for 60 seconds at 25° C. by insulation resistance meter (R8340 made by Advantest). Higher insulation resistance is preferable, and in the present example, samples in which insulation resistance was 1×10¹⁰ MΩ or higher were determined as good. The results are shown in Tables 2 and 4.

(Capacitance Change Rate (TC))

The capacitance was measured in a temperature range of −55 to 150° C. with a digital LCR meter (4284A made by YHP) under a condition of a frequency of 1 kHz and an input signal level (measured voltage) of 1 Vrms. Then, capacitance change rate (unit: %) was calculated at −55° C. and 150° C., with respect to the capacitance at reference temperature of 25° C. In the present example, samples in which capacitance change rate was in the range of −10 to +5% were determined as good. The results are shown in Tables 2 and 4.

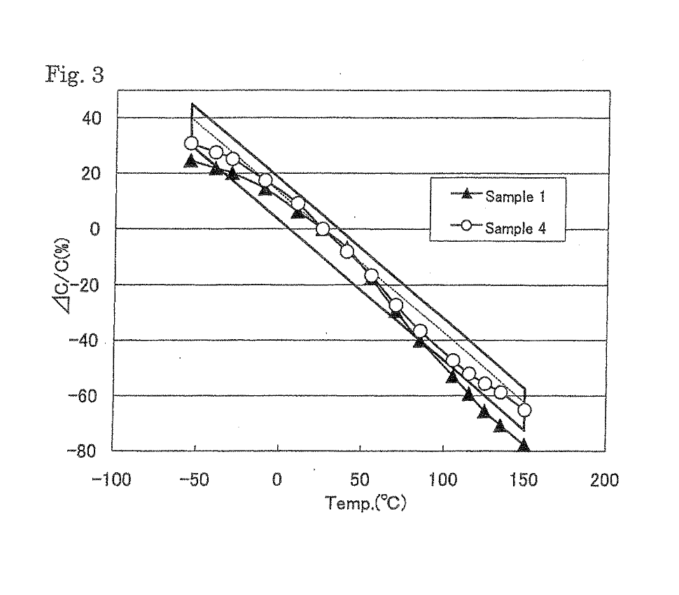

Also, for samples 1 and 4, graphs showing capacitance change rate in the range of −55° C. to 150° C. on the basis of capacitance at 25° C. were shown in FIG. 3.

(High Temperature Load Lifetime (High Temperature Accelerated Lifetime: HALT))

For the capacitor samples, the life time was measured while applying the direct voltage under the electric field of 40 V/μm at 200° C., and thereby the high temperature load lifetime was evaluated. In the present example, the lifetime was defined as the time from the beginning of the voltage application until the insulation resistance drops by one digit. Also, this high temperature load lifetime evaluation was performed to 10 capacitor samples. In the present example, samples in which HALT was 3.1 hours or longer were determined as good. The results are shown in Tables 2 and 4.

(Average Particle Diameter of Sintered Body)

In order to measure an average particle diameter of dielectric particles of sintered body, the obtained capacitor samples were cut at a surface vertical to internal electrode, then said cut surface was polished. After chemical etching the polished surface, the surface was observed with a scanning electron microscope (SEM) and an average particle diameter was measured based an the code method by assuming that the particles have spherical shapes. The results are shown in Tables 2 and 4.

TABLE 1

| | | average | | | | | | | | | mixed composition of first main component | | | | | | contents of subcomponents | | | | |
|---|---|---|---|---|---|---|---|---|---|---|---|---|---|---|---|---|---|---|---|---|---|
| | | particle | | | | | | | | | (a) and second main component (b) (a + b = 1) | | | | | | with respect to 100 moles of main component [mol] | | | | |
| | | diameter | compositions of first main | | | | compositions of second | | | | (Ba_{1-(ax1+bx2)-y}Sr_{(ax1+bx2)}Ca_{y})ₘ(Ti_{1-z}Zr₂)O₃ | | | | | | | | 3rd | | |
| | | of first | component | | | | main component | | | | first: | | | | | | 1st | 2nd | subcom- | | 5th |
| | | and | (Ba_{1-x1-y}Srₓ₁Ca_{y})ₘ(Ti_{1-z}Zr₂)O₃ | | | | (Ba_{1-x2-y}Srₓ₂Ca_{y})ₘ(Ti_{1-z}Zr₂)O₃ | | | | second | ax1 + | | | | | subcom- | subcom- | ponent | 4th | subcomponent |
| | | second | | y | z | m | | y | z | m | a:b | bx2 | | y | z | m | ponent | ponent | (rare | sub- | (V, Mo, W, |
| | | main com- | | 0 | 0 | 0.950 | | 0 | 0 | 0.950 | 20:80 | 0.20 | | 0 | 0 | 0.950 | (Mg) | (Mn, Cr) | earth) | component | Ta, Nb) |
| | item | ponent | x1 | to | to | to | x2 | to | to | to | to | to | x1/x2 | to | to | to | 0.5 | 0.05 to 2 | 1 to 8 | 0.5 to 5 | 0 to 0.2 |
| No. | range | [μm] | — | 0.20 | 0.30 | 1.050 | — | 0.20 | 0.30 | 1.050 | 80:20 | 0.40 | 1.05≦ | 0.20 | 0.30 | 1.050 | to 5 | A | R | kind | D |

| | | | | | | | | | | | | | | | | | | | | | | | | |
|---|---|---|---|---|---|---|---|---|---|---|---|---|---|---|---|---|---|---|---|---|---|---|---|---|
| 1* | 0.35 | 0.2 | 0 | 0 | 1 | 0.2 | 0 | 0 | 1 | 50:50 | 0.2 | 1.00 | 0 | 0 | 1 | 2 | Mn | 0.2 | Y | 4 | BaCaSiO₃ | 3 | V | 0.06 |
| 2* | 0.35 | 0.203 | 0 | 0 | 1 | 0.197 | 0 | 0 | 1 | 50:50 | 0.2 | 1.03 | 0 | 0 | 1 | 2 | Mn | 0.2 | Y | 4 | BaCaSiO₃ | 3 | V | 0.06 |
| 3 | 0.35 | 0.21 | 0 | 0 | 1 | 0.19 | 0 | 0 | 1 | 50:50 | 0.2 | 1.11 | 0 | 0 | 1 | 2 | Mn | 0.2 | Y | 4 | BaCaSiO₃ | 3 | V | 0.06 |
| 4 | 0.35 | 0.3 | 0 | 0 | 1 | 0.1 | 0 | 0 | 1 | 50:50 | 0.2 | 3.00 | 0 | 0 | 1 | 2 | Mn | 0.2 | Y | 4 | BaCaSiO₃ | 3 | V | 0.06 |
| 5 | 0.35 | 0.39 | 0 | 0 | 1 | 0.01 | 0 | 0 | 1 | 50:50 | 0.2 | 39.00 | 0 | 0 | 1 | 2 | Mn | 0.2 | Y | 4 | BaCaSiO₃ | 3 | V | 0.06 |
| 6 | 0.35 | 0.4 | 0 | 0 | 1 | 0 | 0 | 0 | 1 | 50:50 | 0.2 | ∞ | 0 | 0 | 1 | 2 | Mn | 0.2 | Y | 4 | BaCaSiO₃ | 3 | V | 0.06 |
| 7 | 0.35 | 0.4 | 0.2 | 0 | 1 | 0 | 0.2 | 0 | 1 | 50:50 | 0.2 | ∞ | 0.2 | 0 | 1 | 2 | Mn | 0.2 | Y | 4 | BaCaSiO₃ | 3 | V | 0.06 |
| 8 | 0.35 | 0.235 | 0 | 0 | 1 | 0.059 | 0 | 0 | 1 | 80:20 | 0.2 | 4.00 | 0 | 0 | 1 | 2 | Mn | 0.2 | Y | 4 | BaCaSiO₃ | 3 | V | 0.06 |
| 9 | 0.35 | 0.500 | 0 | 0 | 1 | 0.125 | 0 | 0 | 1 | 20:80 | 0.2 | 4.00 | 0 | 0 | 1 | 2 | Mn | 0.2 | Y | 4 | BaCaSiO₃ | 3 | V | 0.06 |
| 10* | 0.35 | 0.4 | 0 | 0 | 1 | 0.4 | 0 | 0 | 1 | 50:50 | 0.4 | 1.00 | 0 | 0 | 1 | 2 | Mn | 0.2 | Y | 4 | BaCaSiO₃ | 3 | V | 0.06 |
| 11* | 0.35 | 0.403 | 0 | 0 | 1 | 0.397 | 0 | 0 | 1 | 50:50 | 0.4 | 1.02 | 0 | 0 | 1 | 2 | Mn | 0.2 | Y | 4 | BaCaSiO₃ | 3 | V | 0.06 |
| 12 | 0.35 | 0.41 | 0 | 0 | 1 | 0.39 | 0 | 0 | 1 | 50:50 | 0.4 | 1.05 | 0 | 0 | 1 | 2 | Mn | 0.2 | Y | 4 | BaCaSiO₃ | 3 | V | 0.06 |
| 13 | 0.35 | 0.7 | 0 | 0 | 1 | 0.1 | 0 | 0 | 1 | 50:50 | 0.4 | 7.00 | 0 | 0 | 1 | 2 | Mn | 0.2 | Y | 4 | BaCaSiO₃ | 3 | V | 0.06 |
| 14 | 0.35 | 0.79 | 0 | 0 | 1 | 0.01 | 0 | 0 | 1 | 50:50 | 0.4 | 79.00 | 0 | 0 | 1 | 2 | Mn | 0.2 | Y | 4 | BaCaSiO₃ | 3 | V | 0.06 |
| 15 | 0.35 | 0.471 | 0 | 0 | 1 | 0.118 | 0 | 0 | 1 | 80:20 | 0.4 | 4.00 | 0 | 0 | 1 | 2 | Mn | 0.2 | Y | 4 | BaCaSiO₃ | 3 | V | 0.06 |
| 16 | 0.35 | 1.000 | 0 | 0 | 1 | 0.250 | 0 | 0 | 1 | 20:80 | 0.4 | 4.00 | 0 | 0 | 1 | 2 | Mn | 0.2 | Y | 4 | BaCaSiO₃ | 3 | V | 0.06 |
| 17* | 0.35 | 0.3 | 0.3 | 0 | 1 | 0.1 | 0.3 | 0 | 1 | 50:50 | 0.2 | 3.00 | 0.3 | 0 | 1 | 2 | Mn | 0.2 | Y | 4 | BaCaSiO₃ | 3 | V | 0.06 |
| 18 | 0.35 | 0.3 | 0.2 | 0 | 1 | 0.1 | 0.2 | 0 | 1 | 50:50 | 0.2 | 3.00 | 0.2 | 0 | 1 | 2 | Mn | 0.2 | Y | 4 | BaCaSiO₃ | 3 | V | 0.06 |
| 19 | 0.35 | 0.3 | 0.15 | 0.2 | 1 | 0.1 | 0.15 | 0.2 | 1 | 50:50 | 0.2 | 3.00 | 0.15 | 0.2 | 1 | 2 | Mn | 0.2 | Y | 4 | BaCaSiO₃ | 3 | V | 0.06 |
| 20 | 0.35 | 0.3 | 0 | 0.3 | 1 | 0.1 | 0 | 0.3 | 1 | 50:50 | 0.2 | 3.00 | 0 | 0.3 | 1 | 2 | Mn | 0.2 | Y | 4 | BaCaSiO₃ | 3 | V | 0.06 |
| 21* | 0.35 | 0.3 | 0 | 0.4 | 1 | 0.1 | 0 | 0.4 | 1 | 50:50 | 0.2 | 3.00 | 0 | 0.4 | 1 | 2 | Mn | 0.2 | Y | 4 | BaCaSiO₃ | 3 | V | 0.06 |
| 22* | 0.35 | 0.3 | 0 | 0 | 0.9 | 0.1 | 0 | 0 | 0.9 | 50:50 | 0.2 | 3.00 | 0 | 0 | 0.9 | 2 | Mn | 0.2 | Y | 4 | BaCaSiO₃ | 3 | V | 0.06 |
| 23 | 0.35 | 0.3 | 0 | 0 | 0.95 | 0.1 | 0 | 0 | 0.95 | 50:50 | 0.2 | 3.00 | 0 | 0 | 0.95 | 2 | Mn | 0.2 | Y | 4 | BaCaSiO₃ | 3 | V | 0.06 |
| 24 | 0.35 | 0.3 | 0 | 0 | 1.05 | 0.1 | 0 | 0 | 1.05 | 50:50 | 0.2 | 3.00 | 0 | 0 | 1.05 | 2 | Mn | 0.2 | Y | 4 | BaCaSiO₃ | 3 | V | 0.06 |
| 25* | 0.35 | 0.3 | 0 | 0 | 1.1 | 0.1 | 0 | 0 | 1.1 | 50:50 | 0.2 | 3.00 | 0 | 0 | 1.1 | 2 | Mn | 0.2 | Y | 4 | BaCaSiO₃ | 3 | V | 0.06 |
| 26** | 0.35 | 0.3 | 0 | 0 | 1 | 0.1 | 0 | 0 | 1 | 50:50 | 0.2 | 3.00 | 0 | 0 | 1 | 0.3 | Mn | 0.2 | Y | 4 | BaCaSiO₃ | 3 | V | 0.06 |
| 27 | 0.35 | 0.3 | 0 | 0 | 1 | 0.1 | 0 | 0 | 1 | 50:50 | 0.2 | 3.00 | 0 | 0 | 1 | 0.5 | Mn | 0.2 | Y | 4 | BaCaSiO₃ | 3 | V | 0.06 |
| 28 | 0.35 | 0.3 | 0 | 0 | 1 | 0.1 | 0 | 0 | 1 | 50:50 | 0.2 | 3.00 | 0 | 0 | 1 | 5 | Mn | 0.2 | Y | 4 | BaCaSiO₃ | 3 | V | 0.06 |
| 29** | 0.35 | 0.3 | 0 | 0 | 1 | 0.1 | 0 | 0 | 1 | 50:50 | 0.2 | 3.00 | 0 | 0 | 1 | 8 | Mn | 0.2 | Y | 4 | BaCaSiO₃ | 3 | V | 0.06 |
| 30** | 0.35 | 0.3 | 0 | 0 | 1 | 0.1 | 0 | 0 | 1 | 50:50 | 0.2 | 3.00 | 0 | 0 | 1 | 2 | Mn | 0.02 | Y | 4 | BaCaSiO₃ | 3 | V | 0.06 |
| 31 | 0.35 | 0.3 | 0 | 0 | 1 | 0.1 | 0 | 0 | 1 | 50:50 | 0.2 | 3.00 | 0 | 0 | 1 | 2 | Mn | 0.05 | Y | 4 | BaCaSiO₃ | 3 | V | 0.06 |
| 32 | 0.35 | 0.3 | 0 | 0 | 1 | 0.1 | 0 | 0 | 1 | 50:50 | 0.2 | 3.00 | 0 | 0 | 1 | 2 | Mn | 2 | Y | 4 | BaCaSiO₃ | 3 | V | 0.06 |
| 33** | 0.35 | 0.3 | 0 | 0 | 1 | 0.1 | 0 | 0 | 1 | 50:50 | 0.2 | 3.00 | 0 | 0 | 1 | 2 | Mn | 3 | Y | 4 | BaCaSiO₃ | 3 | V | 0.06 |
| 34 | 0.35 | 0.3 | 0 | 0 | 1 | 0.1 | 0 | 0 | 1 | 50:50 | 0.2 | 3.00 | 0 | 0 | 1 | 2 | Cr | 0.2 | Y | 4 | BaCaSiO₃ | 3 | V | 0.06 |

samples with mark “*” are out of the range of the present invention.
samples with mark “**” are out of the preferable range of the present invention.

TABLE 2

| | | | | | | capacity | | | |
|---|---|---|---|---|---|---|---|---|---|
| | | average | | | | temperature | | high | |
| | | particle | initial characteristic | | | change | | temperature | |
| | | diameter | specific | dielectric | insulation | rate (TC) [%] | | accelerated | |
| | | of | permittivity | loss | resistance | −55° C. | 150° C. | lifetime | |
| | | sintered | (εs) | (tanδ) [%] | (IR) [MΩ] | −10% | −10% | (HALT) [h] | |
| | item | body | 1000 | 3 | 1.0E+10 | to | to | 3.1 | good or |
| No. | range | [μm] | or more | or less | or more | +5% | +5% | or more | bad |

| 1* | 0.4 | 1800 | 1.6 | 5.0E+11 | −20.0% | −12.0% | 45 | bad |
|---|---|---|---|---|---|---|---|---|
| 2* | 0.4 | 1790 | 1.2 | 4.2E+11 | −16.0% | −11.5% | 35 | bad |
| 3 | 0.4 | 1780 | 1.1 | 5.5E+11 | −9.0% | −9.5% | 32 | good |
| 4 | 0.4 | 1810 | 1.3 | 3.9E+11 | −7.0% | −8.5% | 39 | good |
| 5 | 0.4 | 1760 | 1.1 | 3.2E+11 | −6.5% | −7.0% | 28 | good |
| 6 | 0.4 | 1750 | 1.2 | 2.2E+11 | −6.0% | −5.5% | 17 | good |
| 7 | 0.4 | 1730 | 1.9 | 1.3E+11 | −8.5% | −3.0% | 9.2 | good |
| 8 | 0.5 | 1780 | 0.95 | 3.3E+11 | −8.5% | −9.0% | 22 | good |
| 9 | 0.4 | 1780 | 0.65 | 2.5E+11 | −9.0% | −6.5% | 35 | good |
| 10* | 0.6 | 1140 | 0.45 | 6.1E+11 | −18.5% | −12.0% | 14 | bad |
| 11* | 0.5 | 1120 | 0.85 | 6.6E+11 | −14.5% | −10.0% | 15 | bad |
| 12 | 0.5 | 1150 | 0.78 | 5.8E+11 | −8.5% | −7.5% | 12 | good |
| 13 | 0.5 | 1170 | 0.67 | 5.4E+11 | −6.5% | −5.0% | 18 | good |
| 14 | 0.5 | 1160 | 0.95 | 6.5E+11 | −7.0% | −5.0% | 21 | good |
| 15 | 0.5 | 1150 | 1.1 | 5.7E+11 | −6.5% | −5.5% | 22 | good |
| 16 | 0.4 | 1130 | 0.78 | 4.90E+11 | −8.5% | −3.5% | 31 | good |
| 17* | 0.8 | 1020 | 1.1 | 3.4E+11 | −16.0% | 7.0% | 3.5 | bad |
| 18 | 0.5 | 1180 | 1.1 | 2.4E+11 | −3.0% | −3.0% | 31 | good |
| 19 | 0.4 | 1200 | 0.98 | 7.9E+11 | −9.0% | −2.0% | 39 | good |
| 20 | 0.4 | 1160 | 0.07 | 9.2E+11 | −8.0% | −1.0% | 41 | good |
| 21* | 0.4 | 980 | 0.81 | 2.9E+11 | −33.0% | 14.5% | 43 | bad |
| 22* | — | Do Not Sinter Densely | | | | | | bad |
| 23 | 0.6 | 1320 | 0.92 | 6.9E+11 | −9.0% | −3.0% | 37 | good |
| 24 | 0.4 | 1370 | 0.78 | 4.3E+11 | −6.0% | −8.0% | 29 | good |
| 25* | — | Do Not Sinter Densely | | | | | | bad |
| 26** | 2.1 | 2900 | 2.9 | 2.9E+10 | 23.0% | +12% | 0.08 | bad |
| 27 | 0.6 | 1500 | 1.1 | 6.8E+11 | −8.0% | −9.0% | 75 | good |
| 28 | 0.5 | 1100 | 1.2 | 4.1E+11 | −3.0% | 2.0% | 39 | good |
| 29** | — | Do Not Sinter Densely | | | | | | bad |
| 30** | 0.4 | 1510 | 2.8 | 8.4E+08 | −11.0% | −8.0% | 4.2 | bad |
| 31 | 0.4 | 1380 | 1.7 | 1.9E+11 | −9.0% | −5.0% | 45 | good |
| 32 | 0.5 | 1320 | 1.4 | 9.1E+11 | −6.0% | −5.0% | 12 | good |
| 33** | 0.6 | 1330 | 1.1 | 5.3E+11 | −5.0% | −3.0% | 0.1 | bad |
| 34 | 0.4 | 1380 | 0.55 | 7E+11 | −8.0% | −9.0% | 26 | good |

samples with mark “*” are out of the range of the present invention.
samples with mark “**” are out of the preferable range of the present invention.

TABLE 3

| | | average | | | | | | | | | mixed composition of first main component | | | | | | contents of subcomponents | | | | |
|---|---|---|---|---|---|---|---|---|---|---|---|---|---|---|---|---|---|---|---|---|---|
| | | particle | | | | | | | | | (a) and second main component (b) (a + b = 1) | | | | | | with respect to 100 moles of main component [mol] | | | | |
| | | diameter | compositions of first main | | | | compositions of second | | | | (Ba_{1-(ax1+bx2)-y}Sr_{(ax1+bx2)}Ca_{y})ₘ(Ti_{1-z}Zr₂)O₃ | | | | | | | | 3rd | | 5th |
| | | of first | component | | | | main component | | | | first: | | | | | | 1st | 2nd | subcom- | | subcom- |
| | | and | (Ba_{1-x1-y}Srₓ₁Ca_{y})ₘ(Ti_{1-z}Zr₂)O₃ | | | | (Ba_{1-x2-y}Srₓ₂Ca_{y})ₘ(Ti_{1-z}Zr₂)O₃ | | | | second | ax1 + | | | | | subcom- | subcom- | ponent | 4th | ponent (V, |
| | | second | | y | z | m | | y | z | m | a:b | bx2 | | y | z | m | ponent | ponent | (rare | sub- | Mo, W, |
| | | main com- | | 0 | 0 | 0.950 | | 0 | 0 | 0.950 | 20:80 | 0.20 | | 0 | 0 | 0.950 | (Mg) | (Mn, Cr) | earth) | component | Ta, Nb) |
| | item | ponent | x1 | to | to | to | x2 | to | to | to | to | to | x1/x2 | to | to | to | 0.5 | 0.05 to 2 | 1 to 8 | 0.5 to 5 | 0 to 0.2 |
| No. | range | [μm] | — | 0.20 | 0.30 | 1.050 | — | 0.20 | 0.30 | 1.050 | 80:20 | 0.40 | 1.05≦ | 0.20 | 0.30 | 1.050 | to 5 | A | R | kind | D |

| | | | | | | | | | | | | | | | | | | | | | | | | |
|---|---|---|---|---|---|---|---|---|---|---|---|---|---|---|---|---|---|---|---|---|---|---|---|---|
| 35** | 0.35 | 0.3 | 0 | 0 | 1 | 0.1 | 0 | 0 | 1 | 50:50 | 0.2 | 3.00 | 0 | 0 | 1 | 2 | Mn | 0.2 | Y | 0.2 | BaCaSiO₃ | 3 | V | 0.06 |
| 36 | 0.35 | 0.3 | 0 | 0 | 1 | 0.1 | 0 | 0 | 1 | 50:50 | 0.2 | 3.00 | 0 | 0 | 1 | 2 | Mn | 0.2 | Y | 1 | BaCaSiO₃ | 3 | V | 0.06 |
| 37 | 0.35 | 0.3 | 0 | 0 | 1 | 0.1 | 0 | 0 | 1 | 50:50 | 0.2 | 3.00 | 0 | 0 | 1 | 2 | Mn | 0.2 | Y | 8 | BaCaSiO₃ | 3 | V | 0.06 |
| 38** | 0.35 | 0.3 | 0 | 0 | 1 | 0.1 | 0 | 0 | 1 | 50:50 | 0.2 | 3.00 | 0 | 0 | 1 | 2 | Mn | 0.2 | Y | 12 | BaCaSiO₃ | 3 | V | 0.06 |
| 39 | 0.35 | 0.3 | 0 | 0 | 1 | 0.1 | 0 | 0 | 1 | 50:50 | 0.2 | 3.00 | 0 | 0 | 1 | 2 | Mn | 0.2 | La | 4 | BaCaSiO₃ | 3 | V | 0.06 |
| 40 | 0.35 | 0.3 | 0 | 0 | 1 | 0.1 | 0 | 0 | 1 | 50:50 | 0.2 | 3.00 | 0 | 0 | 1 | 2 | Mn | 0.2 | Ce | 4 | BaCaSiO₃ | 3 | V | 0.06 |
| 41 | 0.35 | 0.3 | 0 | 0 | 1 | 0.1 | 0 | 0 | 1 | 50:50 | 0.2 | 3.00 | 0 | 0 | 1 | 2 | Mn | 0.2 | Pr | 4 | BaCaSiO₃ | 3 | V | 0.06 |
| 42 | 0.35 | 0.3 | 0 | 0 | 1 | 0.1 | 0 | 0 | 1 | 50:50 | 0.2 | 3.00 | 0 | 0 | 1 | 2 | Mn | 0.2 | Nd | 4 | BaCaSiO₃ | 3 | V | 0.06 |
| 43 | 0.35 | 0.3 | 0 | 0 | 1 | 0.1 | 0 | 0 | 1 | 50:50 | 0.2 | 3.00 | 0 | 0 | 1 | 2 | Mn | 0.2 | Sm | 4 | BaCaSiO₃ | 3 | V | 0.06 |
| 44 | 0.35 | 0.3 | 0 | 0 | 1 | 0.1 | 0 | 0 | 1 | 50:50 | 0.2 | 3.00 | 0 | 0 | 1 | 2 | Mn | 0.2 | Gd | 4 | BaCaSiO₃ | 3 | V | 0.06 |
| 45 | 0.35 | 0.3 | 0 | 0 | 1 | 0.1 | 0 | 0 | 1 | 50:50 | 0.2 | 3.00 | 0 | 0 | 1 | 2 | Mn | 0.2 | Tb | 4 | BaCaSiO₃ | 3 | V | 0.06 |
| 46 | 0.35 | 0.3 | 0 | 0 | 1 | 0.1 | 0 | 0 | 1 | 50:50 | 0.2 | 3.00 | 0 | 0 | 1 | 2 | Mn | 0.2 | Dy | 4 | BaCaSiO₃ | 3 | V | 0.06 |
| 47 | 0.35 | 0.3 | 0 | 0 | 1 | 0.1 | 0 | 0 | 1 | 50:50 | 0.2 | 3.00 | 0 | 0 | 1 | 2 | Mn | 0.2 | Ho | 4 | BaCaSiO₃ | 3 | V | 0.06 |
| 48 | 0.35 | 0.3 | 0 | 0 | 1 | 0.1 | 0 | 0 | 1 | 50:50 | 0.2 | 3.00 | 0 | 0 | 1 | 2 | Mn | 0.2 | Yb | 4 | BaCaSiO₃ | 3 | V | 0.06 |
| 49** | 0.35 | 0.3 | 0 | 0 | 1 | 0.1 | 0 | 0 | 1 | 50:50 | 0.2 | 3.00 | 0 | 0 | 1 | 2 | Mn | 0.2 | Y | 4 | BaCaSiO₃ | 0 | V | 0.06 |
| 50 | 0.35 | 0.3 | 0 | 0 | 1 | 0.1 | 0 | 0 | 1 | 50:50 | 0.2 | 3.00 | 0 | 0 | 1 | 2 | Mn | 0.2 | Y | 4 | BaCaSiO₃ | 0.5 | V | 0.06 |
| 51 | 0.35 | 0.3 | 0 | 0 | 1 | 0.1 | 0 | 0 | 1 | 50:50 | 0.2 | 3.00 | 0 | 0 | 1 | 2 | Mn | 0.2 | Y | 4 | BaCaSiO₃ | 5 | V | 0.06 |
| 52** | 0.35 | 0.3 | 0 | 0 | 1 | 0.1 | 0 | 0 | 1 | 50:50 | 0.2 | 3.00 | 0 | 0 | 1 | 2 | Mn | 0.2 | Y | 4 | BaCaSiO₃ | 8 | V | 0.06 |
| 53 | 0.35 | 0.3 | 0 | 0 | 1 | 0.1 | 0 | 0 | 1 | 50:50 | 0.2 | 3.00 | 0 | 0 | 1 | 2 | Mn | 0.2 | Y | 4 | BaSiO₃ | 3 | V | 0.06 |
| 54 | 0.35 | 0.3 | 0 | 0 | 1 | 0.1 | 0 | 0 | 1 | 50:50 | 0.2 | 3.00 | 0 | 0 | 1 | 2 | Mn | 0.2 | Y | 4 | CaSiO₃ | 3 | V | 0.06 |
| 55 | 0.35 | 0.3 | 0 | 0 | 1 | 0.1 | 0 | 0 | 1 | 50:50 | 0.2 | 3.00 | 0 | 0 | 1 | 2 | Mn | 0.2 | Y | 4 | SiO₂ | 3 | V | 0.06 |
| 56 | 0.35 | 0.3 | 0 | 0 | 1 | 0.1 | 0 | 0 | 1 | 50:50 | 0.2 | 3.00 | 0 | 0 | 1 | 2 | Mn | 0.2 | Y | 4 | BaCaSiO₃ | 3 | V | 0 |
| 57 | 0.35 | 0.3 | 0 | 0 | 1 | 0.1 | 0 | 0 | 1 | 50:50 | 0.2 | 3.00 | 0 | 0 | 1 | 2 | Mn | 0.2 | Y | 4 | BaCaSiO₃ | 3 | V | 0.2 |
| 58** | 0.35 | 0.3 | 0 | 0 | 1 | 0.1 | 0 | 0 | 1 | 50:50 | 0.2 | 3.00 | 0 | 0 | 1 | 2 | Mn | 0.2 | Y | 4 | BaCaSiO₃ | 3 | V | 0.3 |
| 59 | 0.35 | 0.3 | 0 | 0 | 1 | 0.1 | 0 | 0 | 1 | 50:50 | 0.2 | 3.00 | 0 | 0 | 1 | 2 | Mn | 0.2 | Y | 4 | BaCaSiO₃ | 3 | Mo | 0.06 |
| 60 | 0.35 | 0.3 | 0 | 0 | 1 | 0.1 | 0 | 0 | 1 | 50:50 | 0.2 | 3.00 | 0 | 0 | 1 | 2 | Mn | 0.2 | Y | 4 | BaCaSiO₃ | 3 | W | 0.06 |
| 61 | 0.35 | 0.3 | 0 | 0 | 1 | 0.1 | 0 | 0 | 1 | 50:50 | 0.2 | 3.00 | 0 | 0 | 1 | 2 | Mn | 0.2 | Y | 4 | BaCaSiO₃ | 3 | Ta | 0.06 |
| 62 | 0.35 | 0.3 | 0 | 0 | 1 | 0.1 | 0 | 0 | 1 | 50:50 | 0.2 | 3.00 | 0 | 0 | 1 | 2 | Mn | 0.2 | Y | 4 | BaCaSiO₃ | 3 | Nb | 0.06 |
| 63 | 0.15 | 0.3 | 0 | 0 | 1 | 0.1 | 0 | 0 | 1 | 50:50 | 0.2 | 3.00 | 0 | 0 | 1 | 2 | Mn | 0.2 | Y | 4 | BaCaSiO₃ | 3 | V | 0.06 |
| 64 | 0.7 | 0.3 | 0 | 0 | 1 | 0.1 | 0 | 0 | 1 | 50:50 | 0.2 | 3.00 | 0 | 0 | 1 | 2 | Mn | 0.2 | Y | 4 | BaCaSiO₃ | 3 | V | 0.06 |

samples with mark “*” are out of the range of the present invention.
samples with mark “**” are out of the preferable range of the present invention.

TABLE 4

| | | | | | | capacity | | | |
|---|---|---|---|---|---|---|---|---|---|
| | | average | | | | temperature | | high | |
| | | particle | initial characteristic | | | change | | temperature | |
| | | diameter | specific | dielectric | insulation | rate (TC) [%] | | accelerated | |
| | | of | permittivity | loss | resistance | −55° C. | 150° C. | lifetime | |
| | | sintered | (εs) | (tanδ) [%] | (IR) [MΩ] | −10% | −10% | (HALT) [h] | |
| | item | body | 1000 | 3 | 1.0E+10 | to | to | 3.1 | good or |
| No. | range | [μm] | or more | or less | or more | +5% | +5% | or more | bad |

| 35** | 1.2 | 1420 | 1.1 | 5.4E+11 | −14.0% | −12.0% | 0.15 | bad |
|---|---|---|---|---|---|---|---|---|
| 36 | 0.4 | 1490 | 0.93 | 7.7E+11 | −9.0% | −1.0% | 25 | good |
| 37 | 0.4 | 1310 | 1 | 9.7E+10 | −6.5% | 2.0% | 35 | good |
| 38** | — | Do Not Sinter Densely | | | | | | bad |
| 39 | 0.9 | 2050 | 1.2 | 3.4E+10 | −9.5% | 3.0% | 5.6 | good |
| 40 | 0.6 | 1950 | 1.2 | 5.5E+10 | −9.0% | 2.0% | 11 | good |
| 41 | 0.5 | 1610 | 1.1 | 8.7E+10 | −8.5% | 1.0% | 18 | good |
| 42 | 0.5 | 1590 | 0.95 | 9.5E+10 | −9.0% | −2.0% | 35 | good |
| 43 | 0.5 | 1560 | 0.91 | 2.1E+11 | −8.5% | −3.5% | 39 | good |
| 44 | 0.4 | 1420 | 0.87 | 2.2E+11 | −7.0% | −4.0% | 45 | good |
| 45 | 0.4 | 1410 | 0.96 | 5.6E+11 | −7.5% | −3.5% | 49 | good |
| 46 | 0.4 | 1360 | 1.1 | 5.2E+11 | −8.0% | −5.5% | 41 | good |
| 47 | 0.4 | 1320 | 1.1 | 5.9E+11 | −7.5% | −8.5% | 30 | good |
| 48 | 0.3 | 1380 | 1 | 2.3E+11 | −7.0% | −3.0% | 14 | good |
| 49** | 0.9 | 2230 | 1.3 | 3.4E+11 | 18.0% | −7.0% | 3.5 | bad |
| 50 | 0.4 | 1530 | 1 | 3.3E+11 | −4.0% | −8.0% | 29 | good |
| 51 | 0.5 | 1230 | 1.1 | 1.2E+11 | −3.0% | −5.0% | 20 | good |
| 52** | — | Do Not Sinter Densely | | | | | | bad |
| 53 | 0.4 | 1520 | 1.3 | 3.2E+11 | −8.5% | −9.0% | 14 | good |
| 54 | 0.4 | 1410 | 0.8 | 1.4E+10 | −8.0% | −5.5% | 22 | good |
| 55 | 0.5 | 1430 | 0.77 | 7.4E+11 | −9.5% | −9.5% | 45 | good |
| 56 | 0.5 | 1430 | 0.98 | 7.8E+11 | −6.0% | −4.0% | 23 | good |
| 57 | 0.4 | 1410 | 1 | 4.3E+10 | −5.5% | −4.5% | 68 | good |
| 58** | 0.4 | 1390 | 1 | 2.1E+09 | −4.0% | −5.5% | 99 | bad |
| 59 | 0.4 | 1310 | 0.87 | 7.7E+10 | −5.5% | −9.0% | 18 | good |
| 60 | 0.4 | 1280 | 0.91 | 1.7E+11 | −7.5% | −8.0% | 12 | good |
| 61 | 0.4 | 1390 | 0.75 | 3.8E+11 | −8.5% | −7.0% | 19 | good |
| 62 | 0.4 | 1380 | 0.65 | 4.4E+11 | −9.0% | −8.0% | 11 | good |
| 63 | 0.2 | 1250 | 0.55 | 5.6E+11 | −6.5% | −3.0% | 65 | good |
| 64 | 1.5 | 1490 | 1 | 4.8E+11 | −9.5% | −4.5% | 7.6 | good |

samples with mark “*” are out of the range of the present invention.
samples with mark “**” are out of the preferable range of the present invention.

As shown in Tables 1 to 4, when “x1/x2” showing Sr ratio in the first main component and Sr ratio in the second main component was out of the range of the present invention (samples 1, 2, 10 and 11), it was confirmed that the capacitance change rate in the range of −65° C. to 150° C. was larger than the range which was considered as good in the present invention, which was not preferable.

Also, when “y”, “z” and “m” in the main component were out of the range of the present invention (samples 17, 21, 22 and 25), it was confirmed that the capacitance change rate was larger than the range which was considered as good in the present invention or that desirable characteristics were not obtained.

Also, the contents of the first to fifth subcomponents were out of the preferable range of the present invention (samples 26, 29, 30, 83, 35, 38, 49, 52 and 58), it was confirmed that the capacitance change rate was larger than the range which was considered as good in the present invention or that desirable characteristics were not obtained.

On the other hand, it was confirmed that in samples of the present invention, the capacitance change rate satisfied the range which was considered as good in the present invention and, in addition, desirable characteristics were attained.

Also, as shown in FIG. 3, it was confirmed visually that although the capacitance change rate in sample 1 failed to satisfy the range which was considered as good in the present invention, the capacitance change rate in sample 4 satisfied the range which was considered as good in the present invention. Namely, it was confirmed that in sample 4, within the range of −55° C. to 150° C., the capacitance change rate on the basis of capacitance at 25° C. was in the range of −10 to +5% with respect to the line showing an extremely large capacity temperature characteristic.

What is claimed is:

1. A production method of a dielectric ceramic composition including a main component expressed by a general formula of (Ba_{1-x-y}SrₓCa_{y})ₘ(Ti_{1-z}Zr_{z})O₃ comprising steps of:
preparing a material of a first main component expressed by a general formula of (Ba_{1-x1-y}Srₓ₁Ca_{y})ₘ(Ti_{1-z}Zr_{z})O₃ and a material of a second main component expressed by a general formula of (Ba_{1-x2-y}Srₓ₂Ca_{y})ₘ(Ti_{1-z}Zr_{z})O₃;
obtaining a material of the main component by mixing said material of the first main component and said material of the second main component; and
firing said material of the main component,
wherein when a molar number of said main component is 1, a molar number of said first main component is “a” and a molar number of said second main component is “b”, a+b=1 and a:b=20:80 to 80:20,
said “x”, “x1”, “x2”, “a” and “b” satisfy relations of 0.20≦x≦0.40, x=(ax1+bx2) and x1/x2≧1.05, and
said “y” is 0≦y≦0.20, said “z” is 0≦z≦0.30 and said “m” is 0.950≦m≦1.050.

2. The production method of a dielectric ceramic composition as set forth in claim 1, wherein
said dielectric ceramic composition comprises:
a first subcomponent consisting of an oxide of Mg;
a second subcomponent consisting of an oxide of at least one kind of element selected from the group consisting of Mn and Cr;
a third subcomponent consisting of an oxide of R, where R is at least one kind selected from the group consisting of Y, La, Ce, Pr, Nd, Sm, Gd, Tb, Dy, Ho and Yb; and
a fourth subcomponent consisting of an oxide including Si,
wherein ratios of the respective subcomponents with respect to 100 moles of said main component are
the first subcomponent: 0.5 to 5 moles in terms of element,
the second subcomponent: 0.05 to 2 moles in terms of element,
the third subcomponent: 1 to 8 moles in terms of element and
the fourth subcomponent: 0.5 to 5 moles in terms of oxide or composite oxide.

3. The production method of a dielectric ceramic composition as set forth in claim 2, wherein
said dielectric ceramic composition further comprises:
a fifth subcomponent consisting of at least one kind of element selected from the group consisting of V, Mo, W, Ta and Nb and a ratio of the fifth subcomponent with respect to 100 moles of said main component is 0 to 0.2 moles in terms of each element.

4. A production method of an electronic device having a dielectric layer and an electrode layer,
wherein said dielectric layer is composed of a dielectric ceramic composition including a main component expressed by a general formula of (Ba_{1-x-y}SrₓCa_{y})ₘ(Ti_{1-z}Zr_{z})O₃, and
the production method comprises steps of:
preparing a material of a first main component expressed by a general formula of (Ba_{1-x1-y}Srₓ₁Ca_{y})ₘ(Ti_{1-z}Zr_{z})O₃ and a material of a second main component expressed by a general formula of (Ba_{1-x2-y}Srₓ₂Ca_{y})ₘ(Ti_{1-z}Zr_{z})O₃;
obtaining a material of the main component by mixing said material of the first main component and said material of the second main component;
forming a dielectric layer before firing including said material of the main component; and
firing said dielectric layer before firing,
wherein when a molar number of said main component is 1, a molar number of said first main component is “a” and a molar number of said second main component is “b”, a+b=1 and a:b=20; 80 to 80:20,
said “x”, “x1”, “x2”, “a” and “b” satisfy relations of 0.20≦x≦0.40, x=(ax1+bx2) and x1/x2≧1.05, and
said “y” is 0≦y≦0.20, said “z” is 0≦z≦0.30 and said “m” is 0.950≦m≦1.050.
